(19) United States
(12) Patent Application Publication
(10) Pub. No.: US 2026/0128326 A1
(43) Pub. Date: May 7, 2026

(54) CURRENT COLLECTOR COMPRISING CONDUCTIVE PRIMER LAYER AND ALL-SOLID-STATE BATTERY COMPRISING THE SAME

(71) Applicants: HYUNDAI MOTOR COMPANY, Seoul (KR); Kia Corporation, Seoul (KR)

(72) Inventors: Seung Hwan MOON, Hwaseong-si (KR); Gyeong Jun CHUNG, Hwaseong-si (KR); So Ri LEE, Hwaseong-si (KR); Seul Gi CHOI, Hwaseong-si (KR); Ju Yeon LEE, Hwaseong-si (KR); Jong Jung KIM, Hwaseong-si (KR)

(73) Assignees: HYUNDAI MOTOR COMPANY, Seoul (KR); Kia Corporation, Seoul (KR)

(21) Appl. No.: 19/220,816

(22) Filed: May 28, 2025

(30) Foreign Application Priority Data
Nov. 4, 2024 (KR) 10-2024-0154679

(51) Int. Cl. H01M 4/66; H01M 4/02; H01M 4/04; H01M 4/74; H01M 4/80; H01M 4/82

(52) U.S. Cl. CPC H01M 4/667; H01M 4/0404; H01M 4/0471; H01M 4/666; H01M 4/669; H01M 4/74; H01M 4/808; H01M 4/82; H01M 2004/021

(57) ABSTRACT

Disclosed are a current collector having a primer layer comprising a conductive material and a binder having a three-dimensional network structure, an electrode for an all-solid-state battery comprising the current collector, an all-solid-state battery comprising the same, and a method for manufacturing the electrode for the all-solid-state battery.

### CROSS-REFERENCE TO RELATED APPLICATION

This application claims the benefit of priority to Korean Patent Application No. 10-2024-0154679, filed in the Korean Intellectual Property Office on Nov. 4, 2024, the entire contents of which are incorporated herein by reference.

### TECHNICAL FIELD

The present disclosure relates to a current collector which has a primer layer disposed on one surface of a substrate and comprising a conductive material and a binder having a three-dimensional network structure to maximize adhesion thereof to an electrode layer, thereby improving performance and durability of an all-solid-state battery, an electrode for an all-solid-state battery comprising the same, and an all-solid-state battery comprising the same.

### BACKGROUND

All-solid-state batteries have the advantage of securing high energy density and safety, and are in the spotlight as a new type of battery that may replace existing lithium-ion batteries. However, since the all-solid-state battery uses a solid as an electrolyte, minimizing the resistance at the interface between the current collector and the electrode layer and the interface between the electrode layer and the solid electrolyte layer is an essential task for enhancing the characteristics of the cell. In particular, the low adhesion force at the interface between the current collector and the electrode layer may induce easy separation of solid particles from the electrode during the process, and an increase in resistance at the interface due to a decrease in the contact area during the repeated charge/discharge process may occur. These problems may have a greater adverse effect while the charge/discharge process is continued, and reduce the movement path of electrons and ions to reduce the charge/discharge efficiency, and may rapidly deteriorate the overall durability of the battery to significantly reduce the electrochemical performance of the all-solid-state battery.

Therefore, there is a need for a current collector design having a new structure capable of maintaining the unique performance of the current collector while maximizing the adhesive force at the interface between the electrode layer and the current collector.

### SUMMARY

The present disclosure has been made to solve the above-mentioned problems occurring in the prior art while advantages achieved by the prior art are maintained intact.

An aspect of the present disclosure provides a current collector capable of solving the above problems, an electrode for an all-solid-state battery comprising the same, and an all-solid-state battery comprising the same.

More specifically, the present disclosure provides a current collector comprising a primer layer disposed on one surface of a substrate and comprising a conductive material and a binder having a three-dimensional network structure to maximize the adhesive force between the primer layer and an electrode layer and to minimize volume change during a charging/discharging process, thereby minimizing the durability deterioration of an electrode and an all-solid-state battery.

The technical problems to be solved by the present disclosure are not limited to the aforementioned problems, and any other technical problems not mentioned herein will be clearly understood from the following description by those skilled in the art to which the present disclosure pertains.

In order to achieve the purpose, (1) the present disclosure provides a current collector comprising: a substrate; and a primer layer disposed on the substrate, wherein the primer layer comprises a conductive material and a binder having a three-dimensional network structure, wherein the binder of the three-dimensional network structure comprises a crosslinking between a polymer having an unsaturated bond and a vulcanizing agent.

(2) The present disclosure provides the current collector of the (1), wherein the conductive material is a sphere-type conductive material.

(3) The present disclosure provides the current collector of the (1) or (2), wherein a BET specific surface area of the conductive material is about 50 m²/g or greater and about 100 m²/g or smaller.

(4) The present disclosure provides the current collector of one of the (1) to (3), wherein the polymer having the unsaturated bond is at least one selected from a group consisting of styrene-butadiene rubber, nitrile-butadiene rubber, and butadiene rubber.

(5) The present disclosure provides the current collector of one of the (1) to (4), wherein the vulcanizing agent comprises a sulfur donor and a vulcanization accelerator.

(6) The present disclosure provides the current collector of one of the (1) to (5), wherein a weight ratio between the sulfur donor and the vulcanization accelerator is in a range of 1:1 to 1:5.

(7) The present disclosure provides the current collector of one of the (1) to (6), wherein a weight ratio between the polymer having the unsaturated bond and the vulcanizing agent is in a range of 5:1 to 10:1.

(8) The present disclosure provides the current collector of one of the (1) to (7), wherein a weight ratio between the conductive material and the binder of the three-dimensional network structure is in a range of 1:1 to 1:4.

(9) The present disclosure provides the current collector of one of the (1) to (8), wherein a thickness of the primer layer is about 0.1 μm or larger and about 20 μm or smaller.

(10) The present disclosure provides the current collector of one of the (1) to (9), wherein the substrate comprises at least one metal selected from a group consisting of Al, Ti, Ni, Cu, and SUS.

(11) The present disclosure provides the current collector of one of the (1) to (10), wherein a thickness of the substrate is about 3 μm or larger and about 30 μm or smaller.

(12) The present disclosure provides the current collector of one of the (1) to (11), wherein the substrate is present in a form of a foil, a mesh, or a foam.

(13) The present disclosure provides an electrode for an all-solid-state battery, comprising: a current collector according to one of the (1) to (12); and an electrode layer disposed on the current collector, wherein the electrode layer comprises an electrode active material and a solid electrolyte.

(14) The present disclosure provides a method for manufacturing an electrode for an all-solid-state battery, the method comprising: (S1) preparing a primer layer slurry comprising a conductive material, a polymer having an unsaturated bond, and a vulcanizing agent; (S2) applying the primer layer slurry on a substrate so as to have a predetermined thickness and drying the primer layer slurry to form a primer layer on the substrate; (S3) additionally applying and drying an electrode slurry comprising an electrode active material and a solid electrolyte on the primer layer to form an electrode layer on the primer layer; and (S4) drying the primer layer under a temperature condition of 120° C. or higher and 180° C. or lower to perform a crosslinking between the polymer having the unsaturated bond and the vulcanizing agent.

(15) The present disclosure provides the method for manufacturing the electrode for the all-solid-state battery of the (14), wherein a weight ratio between the electrode active material and the solid electrolyte in the electrode slurry is in a range of 3:1 to 5:1.

(16) The present disclosure provides the method for manufacturing the electrode for the all-solid-state battery of the (14) or (15), wherein a content of the binder is 1 to 3 parts by weight, a content of the dispersant is 0 to 1 part by weight, and a content of the conductive material is 1 to 2 parts by weight, based on 100 parts by weight of a combination of all materials contained in the electrode slurry.

(17) The present disclosure provides the method for manufacturing the electrode for the all-solid-state battery of one of the (14) to (16), wherein each of the primer layer slurry and the electrode slurry comprises an organic solvent, wherein the organic solvent is at least one selected from the group consisting of butyl butyrate, hexyl butyrate, benzyl acetate o-xylene, toluene, dibromomethane, and anisole.

(18) The present disclosure provides the method for manufacturing the electrode for the all-solid-state battery of one of the (14) to (17), wherein the drying in the (S2) is performed at about 90° C. to about 120° C. for 60 minutes or smaller.

(19) The present disclosure provides the method for manufacturing the electrode for the all-solid-state battery of one of the (14) to (18), wherein the drying in the (S3) is performed at about 90° C. to about 120° C. for 60 minutes or smaller.

(20) The present disclosure provides an all-solid-state battery comprising the electrode for the all-solid-state battery according to the (13).

### DETAILED DESCRIPTION

Hereinafter, the present disclosure will be described in more detail.

Terms or words used in this specification and claims should not be interpreted as limited to their usual or dictionary meanings, and should be interpreted as meanings and concepts that comply with the technical ideas of the present disclosure based on the principle that the inventor may appropriately define the concept of the term in order to explain his or her own invention in the best way.

### Current Collector

The present disclosure provides a current collector comprising a substrate and a primer layer disposed on the substrate, wherein the primer layer comprises a conductive material and a binder having a three-dimensional network structure, and the binder having the three-dimensional network structure comprises a crosslinking between a polymer having an unsaturated bond and a vulcanizing agent.

The current collector of the present disclosure allows the primer layer disposed on the substrate to come into contact with the electrode layer, thereby maximizing contact between the electrode layer and the current collector and thus achieving low interfacial resistance. In addition, the binder comprised in the primer layer has the three-dimensional network structure, which may minimize the movement of particles in the primer layer during the charging and discharging process, thereby improving the adhesion between the primer layer and the electrode layer. In addition, the primer layer may comprise the conductive material to provide excellent electrical conductivity, thereby improving the life characteristics of the electrode while maximizing the effect of improving the adhesion.

### Primer Layer

The primer layer comprised in the current collector of the present disclosure is characterized in that the primer layer comprises the conductive material and the binder having the three-dimensional network structure.

The conductive material is intended for securing electrical conductivity of the primer layer, and in particular, may be a sphere-type conductive material. The sphere-type conductive material may comprise one or more selected from the group consisting of carbon black, acetylene black, ketjen black, and furnace black.

In addition, the BET specific surface area of the conductive material may be about 50 m²/g or greater and about 100 m²/g or smaller, preferably about 55 m²/g or greater, about 60 m²/g or greater, or about 65 m²/g or greater, and about 95 m²/g or smaller, about 90 m²/g or smaller, about 85 m²/g or smaller, or about 80 m²/g or smaller.

When the sphere-type conductive material having the low BET specific surface area as described above is used, the binder is mainly distributed in an upper portion of the primer layer, and the binder distributed in the upper portion of the primer layer may be more strongly bonded to the electrode layer, thereby improving the adhesion between the current collector and the electrode layer.

The binder of the three-dimensional network structure may comprise a crosslinking between the polymer having the unsaturated bond and the vulcanizing agent.

The polymer having the unsaturated bond may be a butadiene rubber-based polymer, and more specifically, may be one or more selected from the group consisting of styrene-butadiene rubber, nitrile-butadiene rubber, and butadiene rubber. The three-dimensional network structure may be formed by reacting the double bonds contained in the polymer with the vulcanizing agent to be described later, and the three-dimensional network structure minimizes the movement of particles in the primer layer to prevent the conductive material from moving to the upper portion of the primer layer during a charge/discharge process, thereby maintaining excellent adhesion.

In one example, the vulcanizing agent may comprise a sulfur donor and a vulcanization accelerator. The sulfur donor is a component that directly forms a crosslinking bond with the polymer having the unsaturated bond. Different polymer chains are crosslinked with each other via the sulfur donor, thereby forming the three-dimensional network structure. The sulfur donor may be elemental sulfur or organic sulfur donor, and the organic sulfur donor may be one or more selected from the group consisting of tetramethyl thiuram disulfide (TMTD), 4,4′-dithiodimorpholine (DTDM), dipentamethylene thiuram tetrasulfide (DPTT), and thiocarbamyl sulfenamide (OTOS).

The vulcanization accelerator is a component for further promoting the crosslinking between the unsaturated bond in the polymer having the unsaturated bond and the sulfur donor, and the vulcanization accelerator may be one or more selected from the group consisting of a thiazole-based vulcanization accelerator, an aldehyde amine-based vulcanization accelerator, a guanidine-based vulcanization accelerator, a thiophosphate-based vulcanization accelerator, a sulfenamides-based vulcanization accelerator, a thiourea-based vulcanization accelerator, a thiuram-based vulcanization accelerator, a dithiocarbamate-based vulcanization accelerator, and a xanthates-based vulcanization accelerator, and preferably a thiazole-based vulcanization accelerator.

The thiazole-based vulcanization accelerator may be one or more selected from the group consisting of 2-mercaptobenzothiazole (MBT), 2-2′-dithiobis(benzenzothiazole) (MBTS), and zinc-2-mercaptobenzothiazole (ZMBT), and preferably 2-mercaptobenzothiazole.

The aldehyde amine-based vulcanization accelerator may be a heptaldehyde-aniline condensation product (BA), and the guanidine-based vulcanization accelerator may be a diphenyl guanidine (DPG), a N,N′-diorthotolyl guanidine (DOTG), or a mixture thereof.

The thiophosphate-based vulcanization accelerator may be zinc-O, O-di-N-phosphorodithioate (ZBDP), and the sulfenamides-based vulcanization accelerator may be one or more selected from the group consisting of N-cyclohexyl-2-benzothiazole sulfenamide (CBS), N-tert-butyl-2-benzothiazole sulfenamide (TBBS), 2-(4-morpholinothio)-benzothiazole (MBS), and N,N′-dicyclohexyl-2-benzothiazole sulfenamide (DCBS).

The thiourea-based vulcanization accelerator may be one or more selected from the group consisting of ethylene thiourea (ETU), di-pentamethylene thiourea (DPTU), and dibutyl thiourea (DBTU).

The thiuram-based vulcanization accelerator may be one or more selected from the group consisting of tetramethylthiuram monosulfide (TMTM), tetramethylthiuram disulfide (TMTD), dipentamethylenethiuram tetrasulfide (DPTT), and etrabenzylthiuram disulfide (TBzTD).

The dithiocarbamate-based vulcanization accelerator may be at least one selected from the group consisting of zinc dimethyldithiocarbamate (ZDMC), zinc diethyldithiocarbamate (ZDEC), zinc dibutyldithiocarbamate (ZDBC), and zinc dibenzyldithiocarbamate (ZDBC).

The xanthates-based vulcanization accelerator may be zinc-isopropyl xanthate (ZIX).

The weight ratio between the sulfur donor and the vulcanization accelerator comprised in the vulcanizing agent may be in a range of 1:1 to 1:5, and preferably 1:1 to 1:4. When the content of the vulcanization accelerator is too small, the improvement effect by the vulcanization accelerator may be insignificant. When the content of the vulcanization accelerator is too high, the content of the sulfur donor may be relatively low, and thus sufficient crosslinking may not be achieved.

The weight ratio between the polymer having the unsaturated bond and the vulcanizing agent may be in a range of 5:1 to 10:1, and preferably 6:1 to 9:1. When the content of the polymer is excessively high, the area in which the crosslinking is not formed via the vulcanizing agent increases, and thus the three-dimensional network structure cannot be sufficiently formed. When the content of the polymer is excessively low, the vulcanizing agent may be excessively comprised to form an amount above a necessary amount of the crosslinking, which may make the binder itself hard, thereby preventing the original role of the binder from being sufficiently performed.

The weight ratio between the conductive material and the binder of the three-dimensional network structure may be in a range of 1:1 to 1:4, preferably 1:1.5 to 1:3.5. When the content of the conductive material is too small, the role of the conductive material may be insignificant. When the content of the conductive material is too high, an excessively comprised conductive material may be positioned in the upper portion of the primer layer to weaken the adhesive force between the primer layer and the electrode layer. In this regard, the weight of the binder of the three-dimensional network structure may mean the weight of the combination of the polymer having the unsaturated bond and the vulcanizing agent.

The thickness of the primer layer may be about 0.1 μm or larger and about 20 μm or smaller, and preferably about 0.5 μm or larger and about 15 μm or smaller. When the thickness of the primer layer is too small, the role of the primer layer itself may not be sufficiently performed. When the thickness of the primer layer is too large, the distance between the substrate and the electrode layer becomes greater, which may be undesirable in terms of electrode performance.

The substrate serves to support the primer layer described above, and a conventional general current collector may be used as the substrate. More specifically, the substrate may comprise one or more metals selected from the group consisting of Al, Ti, Ni, Cu, and SUS. The metals listed above have an advantage in that they have excellent electrical conductivity and excellent mechanical properties and durability.

The thickness of the substrate may be about 3 μm or larger and about 30 μm or smaller, and preferably about 4 μm or larger and about 25 μm or smaller. When the thickness of the substrate is too small, the mechanical strength of the current collector may not meet the minimum level. When the thickness thereof is too large, the economic feasibility of the current collector may be deteriorated.

The form of the substrate may be a foil, a mesh, or a foam. The substrate may have this form to maximize a contact area thereof with the primer layer.

Electrode for all-Solid-State Battery

The present disclosure provides an electrode for an all-solid-state battery comprising the current collector described above.

More specifically, the present disclosure provides an electrode for an all-solid-state battery, which comprises the current collector and an electrode layer disposed on the current collector, wherein the electrode layer comprises an electrode active material and a solid electrolyte.

The electrode may be a positive electrode or a negative electrode depending on the type of the electrode active material comprised in the electrode layer.

When the electrode is the positive electrode, the electrode layer may comprise a positive active material and a solid electrolyte. A known lithium-based positive electrode active material may be used as the positive electrode active material. In addition, the solid electrolyte may also be any known sulfide-based solid electrolyte, chloride-based solid electrolyte, oxide-based solid electrolyte, or the like without limitation.

When the electrode is the negative electrode, the electrode layer may comprise a negative active material and a solid electrolyte. A known carbon-based or silicon-based negative electrode active material may be used as the negative electrode active material. The types of solid electrolytes described above may be used as the solid electrolyte without particular limitation.

The electrode may be the positive electrode or the negative electrode, preferably the positive electrode.

Method for Manufacturing Electrode for all-Solid Battery

The present disclosure provides a method for manufacturing an electrode for an all-solid-state battery described above.

More specifically, the present disclosure provides a method for manufacturing an electrode for an all-solid-state battery, comprising the steps of: (S1) preparing a primer layer slurry comprising a conductive material, a polymer having an unsaturated bond, and a vulcanizing agent; (S2) applying the primer layer slurry on a substrate so as to have a predetermined thickness and drying the primer layer slurry to form a primer layer on the substrate; (S3) additionally applying and drying an electrode slurry comprising an electrode active material and a solid electrolyte on the primer layer to form an electrode layer on the primer layer; and (S4) drying the primer layer under a temperature condition of about 120° C. or higher and about 180° C. or lower to perform a crosslinking between the polymer having the unsaturated bond and the vulcanizing agent.

In the method for manufacturing the electrode for an all-solid-state battery of the present disclosure, the conductive material, the polymer having the unsaturated bond, and the vulcanizing agent may be the same as described above. In addition, the electrode active material and the solid electrolyte may also be the same as described above.

A solvent of the primer layer slurry prepared in step S1 may be an organic solvent. The organic solvent has a boiling point and a vapor pressure at which the organic solvent is capable of being entirely removed under the heat treatment conditions of the vulcanization temperature and time. Further, it is preferable that a component having low reactivity with the solid electrolyte may be used as the solvent.

Specific examples of the organic solvent may be one or more selected from the group consisting of butyl butyrate, hexyl butyrate, benzyl acetate o-xylene, toluene, dibromomethane, and anisole. Preferably, the organic solvent may be butyl butyrate, hexyl butyrate, or a mixture thereof, and preferably butyl butyrate.

The specific temperature and time of drying may vary depending on the volatility of the organic solvent. In one example, the drying in step S2 may be performed at about 90° C. to about 120° C. for 60 minutes or smaller, preferably 30 minutes or smaller. The drying in this step may be performed under a condition in which only the solvent is removed while the crosslinking reaction does not occur.

The solvent of the electrode slurry comprising the electrode active material and the solid electrolyte used in step S3 may be the organic solvent described above. The electrode slurry may further comprise a binder, a dispersant, and a conductive material in addition to the electrode active material and the solid electrolyte. The conductive material may comprise the same conductive material as the previously described conductive material, or a different conductive material from the previously described conductive material. A commonly used conductive material may be used as the conductive material. The binder may also be the binder as described above, or a commonly used binder. A weight ratio between the electrode active material and the solid electrolyte in the electrode slurry may be in a range of 3:1 to 5:1, and the binder may be comprised in an amount of 1 to 3 parts by weight, the dispersant may be comprised in an amount of 0 to 1 part by weight, and the conductive material may be comprised in an amount of 1 to 2 parts by weight, based on 100 parts by a weight of a combination of all materials comprised in the electrode slurry. In one example, all materials comprised in the electrode slurry may be the electrode active material, the solid electrolyte, the conductive material, the dispersant, and the binder.

The drying of step S3 may also be performed at about 90° C. to about 120° C. for 60 minutes or smaller, preferably 30 minutes or smaller, in a similar manner to the drying of step S2. The drying in this step may be performed under a condition in which only the solvent is removed while the crosslinking reaction does not occur.

After forming the primer layer on the substrate and forming the electrode layer on the primer layer through the above process, the crosslinking is finally induced through step S4, such that the binder of the primer layer may have the three-dimensional network structure. Step S4 may be the drying step under a temperature condition of 120° C. or higher and 180° C. or lower to perform the crosslinking between the polymer having the unsaturated bond and the vulcanizing agent, and the drying may be performed for 4 to 10 hours. In this step, the crosslinking between the vulcanizing agent and the polymer having the unsaturated bond may occur.

### All-Solid-State Battery

The present disclosure provides an all-solid-state battery comprising the electrode for the all-solid-state battery as described above.

When the electrode for the all-solid-state battery is a positive electrode, the all-solid-state battery may further comprise a negative electrode and a solid electrolyte layer interposed between the positive electrode and the negative electrode.

When the electrode for the all-solid-state battery is a negative electrode, the all-solid-state battery may further comprise a positive electrode and a solid electrolyte layer interposed between the negative electrode and the positive electrode.

Hereinafter, the present disclosure will be described in more detail with reference to Examples. However, the following Examples are for illustrating the present disclosure, and the scope of the present disclosure is not limited thereto.

### Material

Butadiene rubber (BR) was used as a polymer having an unsaturated bond. The vulcanizing agent was obtained by mixing an organic sulfur and 2-mercaptobenzothiazole (MBT) as the vulcanization accelerator with each other in a weight ratio of 1:1. As the conductive material, carbon black having a BET specific surface area of 70 m²/g and carbon nanotubes having a BET specific surface area of 200 m²/g were used.

A foil-type Al substrate was used as the substrate.

### Examples and Comparative Examples

The polymer, the vulcanizing agent, and the conductive material of the above materials were mixed with each other in a weight ratio of Table 1 as set forth below, and the mixture was added to hexyl butyrate which is an organic solvent, to prepare a slurry for forming the primer layer. The slurry was applied to the substrate of the material so as to have a thickness of about 0.7 μm and was dried at a temperature of about 90° C. for 15 minutes.

Thereafter, a slurry comprising a NCM-based positive electrodeactive material and an azyrodite-based solid electrolyte was applied onto the previously formed primer layer, and then dried at a temperature of about 90° C. for 15 minutes.

After the primer layer and the positive electrode layer were finally formed, the primer layer and the positive electrode layer were put into a vacuum chamber and dried at a temperature of 140° C. for 4 hours to prepare a positive electrode for an all-solid-state battery. The positive electrode slurry used in Example 3 comprises the same component as that used in Example 1 except that only the contents of the binder are different from each other.

TABLE 1

| | | | | | Positive |
|---|---|---|---|---|---|
| | | | | | electrode |
| | | | Conductive | Conductive | layer |
| | Binder | Vulcanizing | material | material | binder |
| | ratio | agent ratio | ratio | type | content |
| Example 1 | 100 | 10 | 36.67 | Carbon | 2.0 wt % |
| | | | | black | |
| Example 2 | 100 | 10 | 36.67 | Carbon | 2.0 wt % |
| | | | | nanotube | |
| Example 3 | 100 | 10 | 36.67 | Carbon | 1.8 wt % |
| | | | | black | |
| Comparative | 100 | 0 | 33.3 | Carbon | 2.0 wt % |
| Example | | | | black | |

### Experimental Example 1. Measurement of DC-IR and Life Characteristics of all-Solid-State Battery Comprising Positive Electrode for all-Solid-State Battery

DC-IR and life characteristics of all-solid-state batteries comprising the positive electrodes prepared in Examples and Comparative Example were measured. Specifically, an all-solid-state battery was constructed under the same conditions except that the positive electrodes prepared in Examples and Comparative Example were used. Each all-solid-state battery was charged and discharged at a constant current (CC) at a first cycle under a voltage of 2.0 to 4.25V, a current of 0.2C (8.8 mA), and a temperature of 30° C. Then, CC charging was performed at 4.25V at a second cycle, and CC discharge was performed up to 50% of the discharge capacity of the first cycle, and then CC discharge was performed at a current of 0.33C (14.7 mA) for 10 seconds. At this time, the DC-IR value (ΔV/I) was derived through the ratio between the reduced voltage and the applied current for discharge of 10 seconds. Then, charging and discharging were performed at a rate of 0.2C (8.8 mA) from a third cycle, and the capacity retention rate relative to the capacity of the third cycle was measured, and durability evaluation was performed. The results are shown in Table 2 below.

TABLE 2

| | | Lifetime |
|---|---|---|
| | DC-IR [Ω] | (60 cyc) |
| Example 1 | 16.2 | 87.0% |
| Example 2 | 18.4 | 76.9% |
| Example 3 | 15.5 | 91.0% |
| Comparative | 17.8 | 84.4% |
| Example | | |

As shown in the results of Table 2, in the case of the all-solid-state battery using the positive electrode of Example of the present disclosure, low resistance and excellent lifespan characteristics were exhibited, and this improvement was particularly evident when the sphere-type conductive material was used.

### Experimental Example 2. Identification of Adhesive Strength of Positive Electrode Layer

In the positive electrodes for all-solid-state batteries prepared in Examples and Comparative Example, the adhesive strength between the primer layer and the positive electrode layer was identified. More specifically, the tensile strength of the prepared positive electrode specimen was measured at a rate of 30 mm/min in the horizontal direction (180 degrees) peeling using an UTM (Universal Testing Machine). The adhesion values of Examples 1 to 3 were expressed as relative values based on the adhesion value of Comparative Example being set to 1.

In addition, it was identified whether the foil as the substrate was exposed due to detachment in the process of mold notching the positive electrodes prepared in Examples and Comparative Example. The results of measuring the adhesion and checking whether the foil is exposed are summarized in Table 3.

TABLE 3

| | Adhesion | |
|---|---|---|
| | force | Exposure of foil due to |
| | (relative | detachment during mold |
| | value) | notching |
| Example 1 | 2.40 | X |
| Example 2 | 1.15 | X |
| Example 3 | 1.80 | X |
| Comparative | 1.00 | O |
| Example | | |

As may be identified from Table 3 above, in Example in which the primer layer comprising the binder having the three-dimensional network structure is applied, high adhesion between the electrode layer and the substrate was identified. However, in the case of the Comparative Example using the conventional general binder alone, low adhesion was exhibited, and the electrode layer was easily removed even in the mold notching process, and the substrate was easily exposed.

From this fact, it may be identified that when the current collector of the present disclosure is used, the adhesive force between the electrode layer and the current collector may be maintained at an excellent level, and the performance of the electrode itself may be maintained at an excellent level.

The current collector of the present disclosure contacts the electrode layer via the primer layer disposed on the substrate, and the primer layer may achieve better contact with the electrode layer, thereby lowering the interfacial resistance and improving the performance of the electrode.

In addition, the primer layer comprises the binder having the three-dimensional network structure, and the binder suppresses the movement of particles in the primer layer during the charging and discharging process, thereby improving the adhesion between the current collector and the electrode layer.

In addition, since the primer layer comprises the conductive material having high dispersibility, a relatively larger amount of the binder may be distributed in the upper area of the primer layer, thereby maximizing the improvement of adhesion and improving the lifetime characteristics of the electrode.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

As used herein, the terms “substantially,” “about,” and “approximately” may provide an industry-accepted tolerance for their corresponding terms and/or relativity between items, such as a tolerance of ±1%, ±5%, or ±10% of the actual value stated, and other suitable tolerances.

What is claimed is:

1. A current collector comprising:
a substrate; and
a primer layer disposed on the substrate,
wherein the primer layer comprises a conductive material and a binder having a three-dimensional network structure,
wherein the binder of the three-dimensional network structure comprises a crosslinking between a polymer having an unsaturated bond and a vulcanizing agent.

2. The current collector of claim 1, wherein the conductive material is a sphere-type conductive material.

3. The current collector of claim 1, wherein a BET specific surface area of the conductive material is 50 m²/g or greater and 100 m²/g or smaller.

4. The current collector of claim 1, wherein the polymer having the unsaturated bond is at least one selected from a group consisting of styrene-butadiene rubber, nitrile-butadiene rubber, and butadiene rubber.

5. The current collector of claim 1, wherein the vulcanizing agent comprises a sulfur donor and a vulcanization accelerator.

6. The current collector of claim 5, wherein a weight ratio between the sulfur donor and the vulcanization accelerator is in a range of 1:1 to 1:5.

7. The current collector of claim 1, wherein a weight ratio between the polymer having the unsaturated bond and the vulcanizing agent is in a range of 5:1 to 10:1.

8. The current collector of claim 1, wherein a weight ratio between the conductive material and the binder of the three-dimensional network structure is in a range of 1:1 to 1:4.

9. The current collector of claim 1, wherein a thickness of the primer layer is 0.1 μm or larger and 20 μm or smaller.

10. The current collector of claim 1, wherein the substrate comprises at least one metal selected from a group consisting of Al, Ti, Ni, Cu, and SUS.

11. The current collector of claim 1, wherein a thickness of the substrate is 3 μm or larger and 30 μm or smaller.

12. The current collector of claim 1, wherein the substrate is present in a form of a foil, a mesh, or a foam.

13. An electrode for an all-solid-state battery, comprising:
the current collector according to claim 1; and
an electrode layer disposed on the current collector,
wherein the electrode layer comprises an electrode active material and a solid electrolyte.

14. A method for manufacturing an electrode for an all-solid-state battery, the method comprising:
preparing a primer layer slurry comprising a conductive material, a polymer having an unsaturated bond, and a vulcanizing agent;
applying the primer layer slurry on a substrate so as to have a predetermined thickness and drying the primer layer slurry to form a primer layer on the substrate;
additionally applying and drying an electrode slurry comprising an electrode active material and a solid electrolyte on the primer layer to form an electrode layer on the primer layer; and
drying the primer layer under a temperature condition of 120° C. or higher and 180° C. or lower to perform a crosslinking between the polymer having the unsaturated bond and the vulcanizing agent.

15. The method for manufacturing the electrode for the all-solid-state battery of claim 14, wherein a weight ratio between the electrode active material and the solid electrolyte in the electrode slurry is in a range of 3:1 to 5:1.

16. The method for manufacturing the electrode for the all-solid-state battery of claim 14, wherein a content of the binder is 1 to 3 parts by weight, a content of the dispersant is 0 to 1 part by weight, and a content of the conductive material is 1 to 2 parts by weight, based on 100 parts by weight of a combination of all materials contained in the electrode slurry.

17. The method for manufacturing the electrode for the all-solid-state battery of claim 14, wherein each of the primer layer slurry and the electrode slurry comprises an organic solvent,
wherein the organic solvent is at least one selected from the group consisting of butyl butyrate, hexyl butyrate, benzyl acetate o-xylene, toluene, dibromomethane, and anisole.

18. The method for manufacturing the electrode for the all-solid-state battery of claim 14, wherein the drying in the (S2) is performed at 90° C. to 120° C. for 60 minutes or smaller.

19. The method for manufacturing the electrode for the all-solid-state battery of claim 14, wherein the drying in the (S3) is performed at 90° C. to 120° C. for 60 minutes or smaller.

20. An all-solid-state battery comprising the electrode for the all-solid-state battery according to claim 13.
